(19) United States
(12) Patent Application Publication
(10) Pub. No.: US 2013/0026337 A1
(43) Pub. Date: Jan. 31, 2013

(54) CASTING MOULD KIT

(71) Applicant: Lars Svensson, Stockholm (SE)

(72) Inventor: Lars Svensson, Stockholm (SE)

(21) Appl. No.: 13/639,713

(22) PCT Filed: Apr. 8, 2011
(86) PCT No.: PCT/SE2011/050429

§ 371 Date: Oct. 5, 2012

(30) Foreign Application Priority Data
Apr. 8, 2010 (SE) 1050340-7

(51) Int. Cl. B28B 7/20

(52) U.S. Cl. 249/98

(57) ABSTRACT

The present invention relates to a easting mould kit which is easy both to assemble and disassemble and which comprises very few parts, Such a casting mould kit is used for moulding construction models. The kit comprises a base (2) plate provided with a grid of dowels (4) on one side of the base plate (2) and wall pieces (8) having a rectangular shape and provided with dowels (4) on a upper rim (10) and with recesses (14) on a lower rim (12) of the wall piece (8), The kit also comprises rod shaped roof pieces (22) having a substantially triangular cross section provided with dowels (4) on an upper rim (40) and recesses (14) at the lower base of the roof shaped piece (22) and having an roof side (24) with an inclination which is the opposite of the inclination of a short end side (26) of the roof piece (22),

### TECHNICAL FIELD OF THE INVENTION

The present invention relates to a casting mould kit. With such a kit it is possible to build casting moulds that may be used for moulding construction models, such as houses.

### DESCRIPTION OF RELATED ART

Today there are many hobbyists that build model houses and other constructions models, for example in conjunction with arranging landscapes for model railroading. The houses may be available as prefabricated model kits, which are easy to assemble. The drawback with such prefabricated models is that the hobbyist has no influence on the design of the models. Thus, it is not possible for the hobbyist to tailor the construction models to the landscape. There have been made attempts to solve the problem with predetermined designs.

One such example is described in U.S. Pat. No. 5,002,513, which discloses a model building kit deploying interchangeable wall panels to create a variety of building designs. The wall panels are further made up of sub-units which make it possible for a user to build individual wall panels. The wall panels interconnect with one another and are vertically supported by columns. Even if this solution gives a user a. wide variety of design options, the kit comprises a lot of individual parts which make it complicated and/or expensive to manufacture such a kit.

Another example is GB Patent no, 546,860, which discloses a casting mould for moulding toy construction elements, Which may be assembled to form models. In the casting mould there may be provided cores of different shapes, mandrels or partitions in order to produce constructional elements of different shapes. This renders the construction very complex and it will also be time consuming to set up the casting mould for a desired design.

U.S. Pat. No. 4,253,637 discloses a casting mould for toy structural elements, Clamping rails are arranged on a base plate spaced apart but parallel to each other and secured to the base plate in an adjustable manner. Between the clamping rails there may be located end and moulding pieces. There are a variety of different moulding pieces in order to design different structural elements.

In GB Patent no. 546860 there is disclosed a casting mould for production of toy or model buildings. The mould consists of moveable parts that may be pinned on a base plate. Also this casting mould is fairly complex and requires a lot of individual pieces for different designs.

Finally, FR Patent no 2416102 describes a casting mould for creating model buildings. Also this casting mould is complex and requires a lot of individual parts in order to get a. variety^{,} of designs.

Thus, there have been made many attempts, during an extended period of time, to accomplish an easy and simple casting mould for forming construction models, such as different buildings. However, as the examples above show they are still complex and require many different parts in order to be able to mould or assemble different and personalized construction models.

### SUMMARY OF INVENTION

It is an object of the present invention to provide a casting mould kit which is easy both to assemble and disassemble and which comprises as few parts as possible.

This object is achieved with a casting mould kit for moulding building models comprising a base plate provided with a grid of dowels on one side of the base plate, The kit further comprises wall pieces having a rectangular shape and provided with dowels on a upper rim and with recesses on a lower rim of the wall piece. The kit also comprises rod shaped roof pieces having a substantially triangular cross section provided with dowels on an upper rim and recesses at the lower base of the roof shaped piece and having a roof side with an inclination which is the opposite of the inclination of a short end side of the roof piece.

With such a kit it will be easy to assemble the casting mould in many different ways in order to mould many different construction models using just the few pieces of the casting mould kit. The casting mould created by the present invention is also very easy to disassemble.

According to another object of the present invention there is provided a casting mould kit in Which the dowels have a cross like cross section. This will secure that the different pieces of the kit are assembled with no slippage between the pieces in the kit.

According to a further object of the present invention the wall piece of the casting mould kit comprises a casting side that is hollow. This hollow space may then be filled with clay and the user may emboss this casting side according to his on individual desire.

According to yet another object of the present invention the casting side is provided with recesses for receiving adornments. By making it possible to attach adornments to the casting side the use may further enhance the individuality of the construction model.

According to a further object of the present invention the casting mould kit further comprises securing pieces. By using these securing pins the slippage between the wall pieces will be further reduced.

According to yet another object of the present invention the casting mould kit further comprises roof eveners. Such roof eveners are used for avoiding to get dowel marks on the roof of the finished product.

According to a further object of the present invention there is provided the casting mould kit further comprises a roof piece having a hollow roof side.

### BRIEF DESCRIPTION OF THE DRAWINGS

Further objects, features, and advantages of the invention will appear from the following description of several embodiments of the invention, wherein various aspects of the invention will be described in more detail with reference to the accompanying drawings, in which:

FIG. 1a is a perspective view of a base plate of the present invention,

FIG. 1b is an enlarged view of a cross like dowel,

FIG. 2a is a front view of a wall piece according to a first embodiment,

FIG. 2b is a perspective view of the wall piece according to a second embodiment, in which the wall piece is provided with recesses,

FIG. 2c is a perspective view of an adornment, in form of a window, adapted to fit in a recess of the wall piece,

FIG. 2d is a front view of a third embodiment of the wall piece, in which the casting side is hollow,

FIG. 3a is a side view of a roof piece according to a first embodiment,

FIG. 3b is a perspective view of a second embodiment of the roof piece, in which the casting side is hollow,

FIG. 3c is a perspective view of the roof piece according to a third embodiment,

FIG. 3d is a cross section of the roof piece shown in FIG. 3a,

FIG. 3e is a cross section of a roof piece according to the third embodiment,

FIG. 4a is a perspective view of a roof piece according to a fourth embodiment,

FIG. 4b is a cross section of the roof piece shown in FIG. 4a,

FIG. 5a is a perspective view of a roof piece according to a fifth embodiment,

FIG. 5b is a cross section of the roof piece shown in FIG. 5a,

FIGS. 6a-i are perspective views of the step by step assembling of the casting mould and also a view of the moulded end product.

FIGS. 7a and 7b are perspective views of a securing piece,

FIGS. 8a-d are perspective views of another way of assembling the casting mould, using the same pieces, but achieving another end product, and

FIGS. 9a-c show yet another example of how the casting mould according to the present invention may be assembled, yielding a third end product,

FIGS. 10a-c show yet another example of how the casting mould according to the present invention may he assembled, yielding a fourth end product.

### DETAILED DESCRIPTION OF THE INVENTION

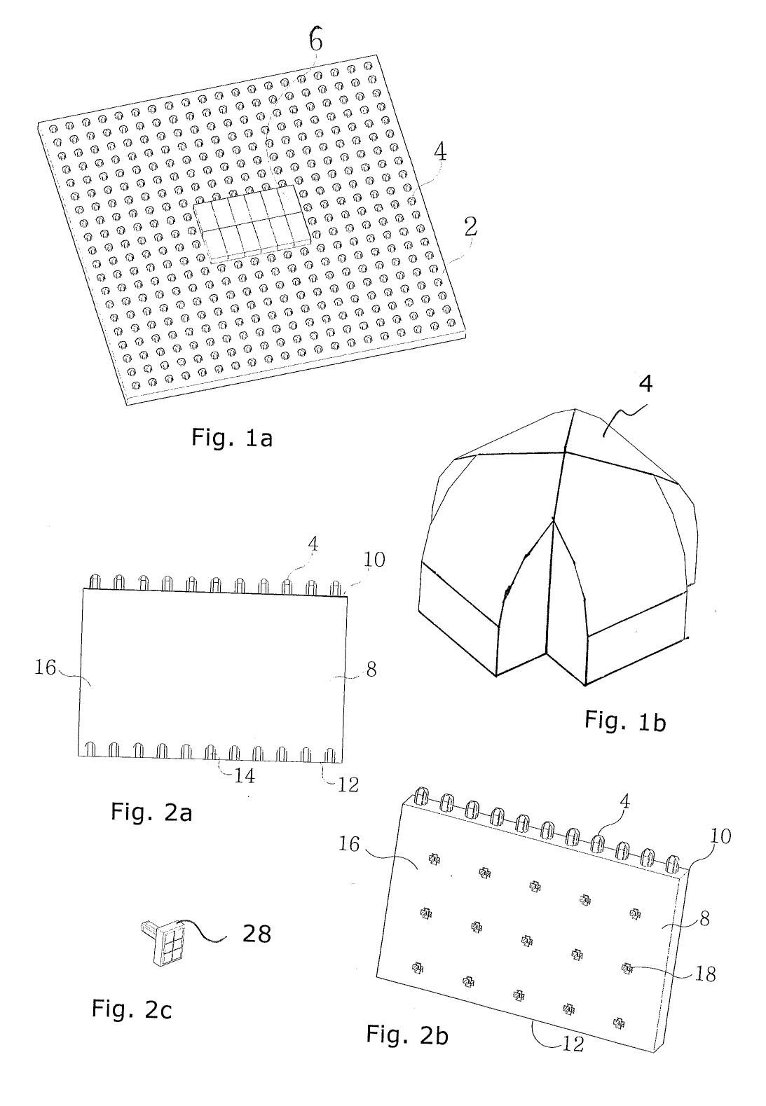

FIGS. 1 to 5 show the basic pieces that constitute the casting mould kit according to the present invention. In its simplest form the kit comprises a base plate, four wall pieces and four roof pieces. The base plate 2 is shown in FIG. 1a. It may have any shape, but a rectangular or square plate is preferred. The base plate 2 serves as a foundation when assembling the casting mould according to the present invention. Thus the shape is not important, but it will be easier to manufacture a square or rectangular base plate 2 then any other shape. As is evident from figure la the base plate 2 is provided with a grid of dowels 4, one of which is closer depicted in FIG. 1b. FIG. 1b shows a dowel 4 having a cross like cross section provided within a basic circular shape. It may also he square or circular in cross section, but the cross like shape has some advantages, Which will be described below. The distance between the dowels 4 is the same for all dowels. This is an important feature, since this will make the casting mould kit very. In FIG. 1a the base plate 2 is also provided with roof eveners 6, to be described further below.

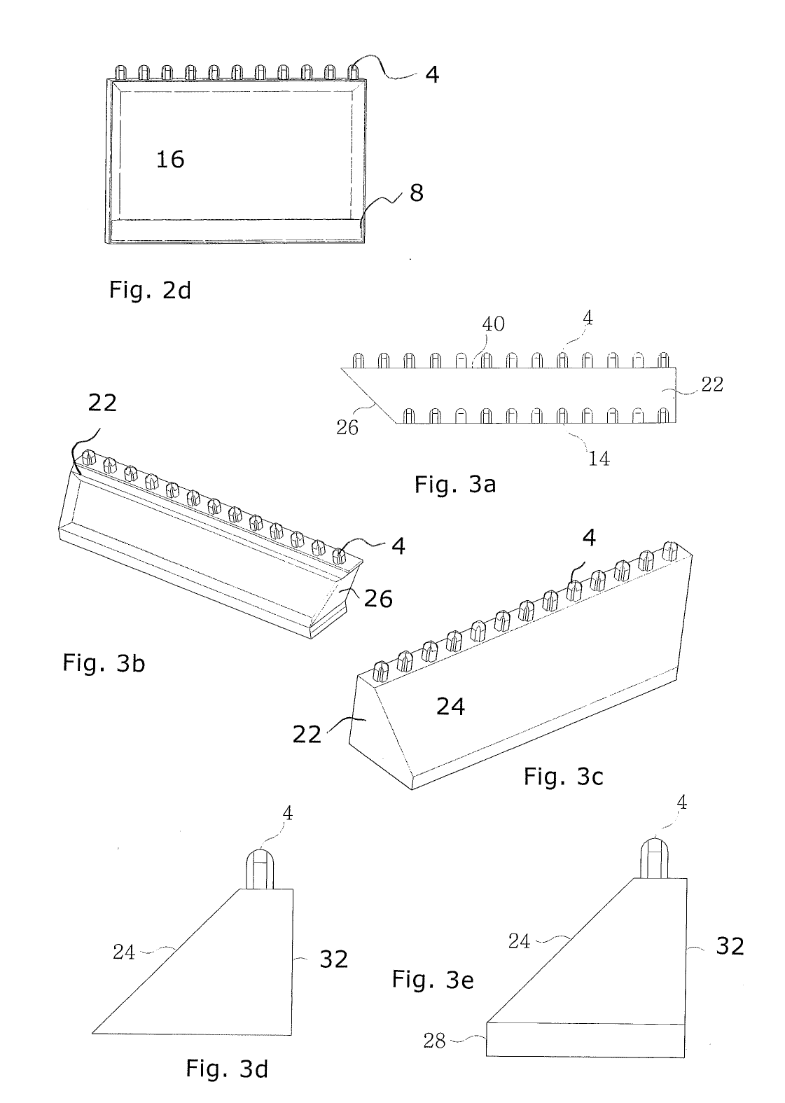

FIGS. 2a-d all show embodiments of the wall pieces 8 comprised in the casting mould kit. FIG. 2a is a front view and FIGS. 2b and 2d are perspective views of the wall piece 8. As mentioned above the kit comprises at least four wall pieces 8. As for the base plate 2, also the wall pieces 8 are provided with dowels 4. These dowels 4 have the same shape and the same distance between them as the base plate 2 and are provided on the upper rim 10 of the wall piece. The lower rim 12 of the wall piece 8 is provided with recesses 14, the shape of which. are adapted to receive the dowels 4. Thus, the distance between the recesses 14 is the same as between the dowels 4. The wall piece further comprises a casting side 16, which is the side of the wall piece 8 that is turned towards the inside of the casting mould, i.e. will be in contact with the casting material used for moulding the construction models. The casting side 16 may be embossed, such that it gives the final construction model a. pleasant and realistic look. If the construction model, for example, is a house the embossment of the casting side 16, may look like a brick wall or a wooden front. In a preferred embodiment of the present invention the wall piece 8 comprises two casting sides 16, such that one side for example may be embossed as brick wall and the other side as a wooden front. This will make the casting mould kit even more and usable. In another embodiment of the present invention may the casting side 16 or one of the casting sides he hollow and this side may be filled with clay or similar material. This embodiment will give the user the possibility to create his own embossment and tailor the appearance of the construction model as he wishes. Such a hollow wall piece is shown in FIG. 2d.

In yet another embodiment of the present invention the casting side 16 may also be provided with recesses 18, as is shown in FIG. 2b. In these recesses 18 the user may push adornments 28, as is shown in FIG. 2c, to decorate the construction model. If the construction model is a building, the adornments may be windows 28 or doors.

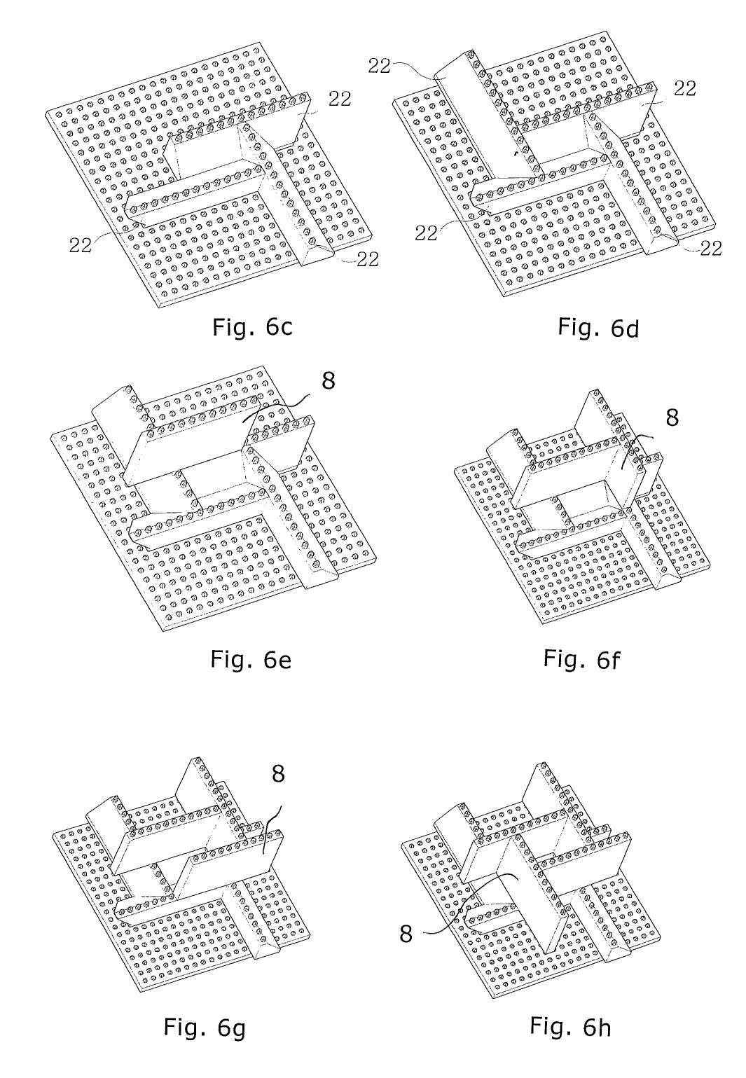

Turning now to FIGS. 3-5, the roof pieces 22 will be described. The roof piece is generally rod shaped with a substantially triangular cross section. A first embodiment of the roof piece 22 is shown in FIGS. 3a and 3d. As is evident from FIG. 3a, also the roof piece is provided with dowels 4 and recesses 14, corresponding to and having the same distance therein between as the wall piece 8. The inclination of the roof side 24, i.e. the side of the roof piece that is turned towards the inside of the casting mould when it is assembled may vary, but is the same for all four roof pieces included in the basic kit. One of the short ends 26 of the roof piece has the opposite inclination as the roof side 24. This will be explained closer in conjunction with FIGS. 6-10, which show the assembling of the casting mould according to the present invention.

As for the wall pieces 8, also the roof side 24 of the roof pieces may be embossed to, for example, create a. tile design. It may also he possible to have a roof side 24 that is hollow as is shown in FIG. 3b. This will, as mentioned above, give a user the opportunity to make his own design.

FIGS. 3c and 3e show another embodiment of the cross section of the roof piece 22. As is evident in the figures, the lower part of the roof side 24 is chamfered. The amount of chamfering corresponds to the height of the roof eveners 6 described above in conjunction with figure la and which will be described further below.

Furthermore, the side opposite the roof side 24 is a vertical wall 32, as shown in FIGS. 3d and 3e. In a preferred embodiment of the present invention this side may also be used as a wall side, possible with embossments or being hollow as has been described above.

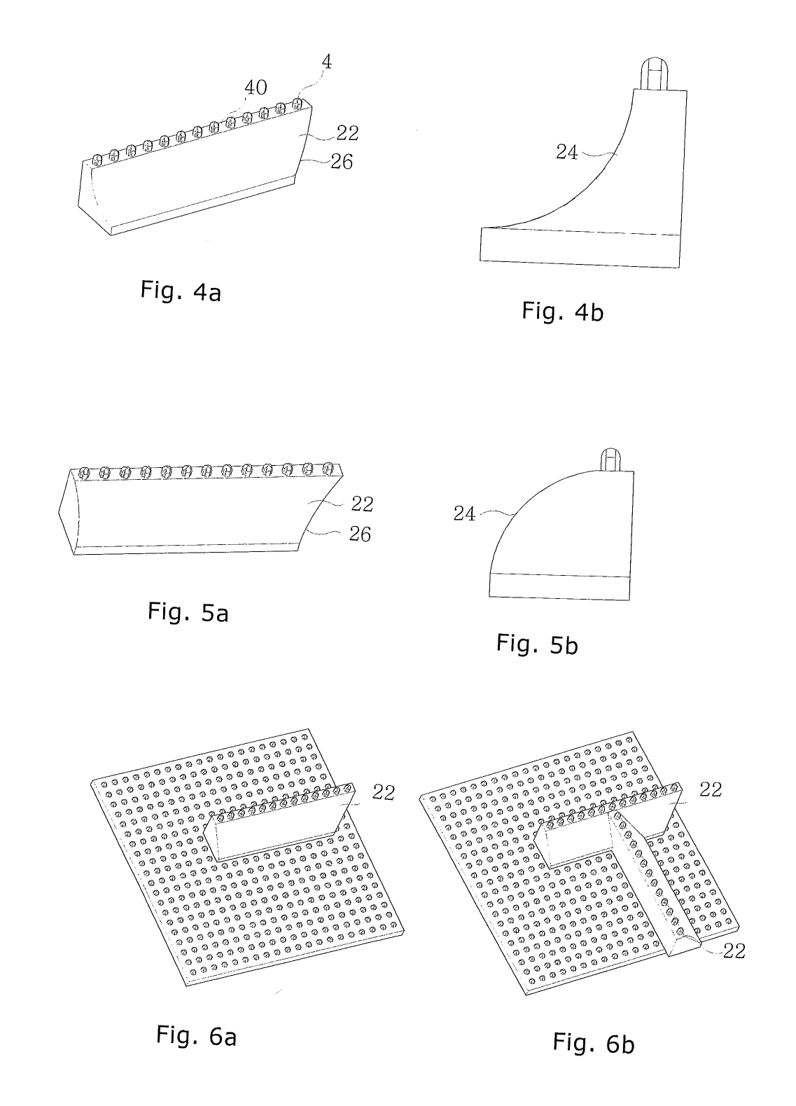

Also FIGS. 4-5 show roof pieces 22 that correspond to the roof piece depicted in FIG. 3. The common features will therefore not be described again. The difference between the embodiments compared with the embodiment in FIG. 3 is that the roof side 24 is a little concave in FIG. 4 and a little convex in FIG. 5. Thus, also the short ends 26 of the roof pieces are shaped differently, such that the short ends 26 match with the concave and convex roof side 24, respectively.

In order to better understand the present invention, several examples will now be given how the casting mould may be assembled in order to create construction models of different shapes, but using the same basic parts. Thus, FIG. 6 shows how the casting mould is assembled step by step in order to create a house. First the four roof pieces 22 are assembled on the basic plate 2. When all four pieces are in place, the roof part of the casting mould is finished. Thereafter the wall pieces 8 are put on top of the roof pieces by matching the recesses of the wall pieces with the dowels of the roof pieces. Thus, in FIG. 6h the final casting mould is shown. Then the hollow space created by the assembled casting mould may be filled with some hardening material such as cement, lime, gypsum or the like. When the hardening material has hardened the casting mould may he disassembled and the finished product is shown in FIG. 6i.

If one looks at the finished product, shown in FIG. 6i, it should be noted that the “roof” at the short side of the house is vertical. Thus, when assembling the casting mould for this specific house, two of the roof pieces have had their inclined side as casting sides and two of the roof pieces have had their vertical sides as casting sides.

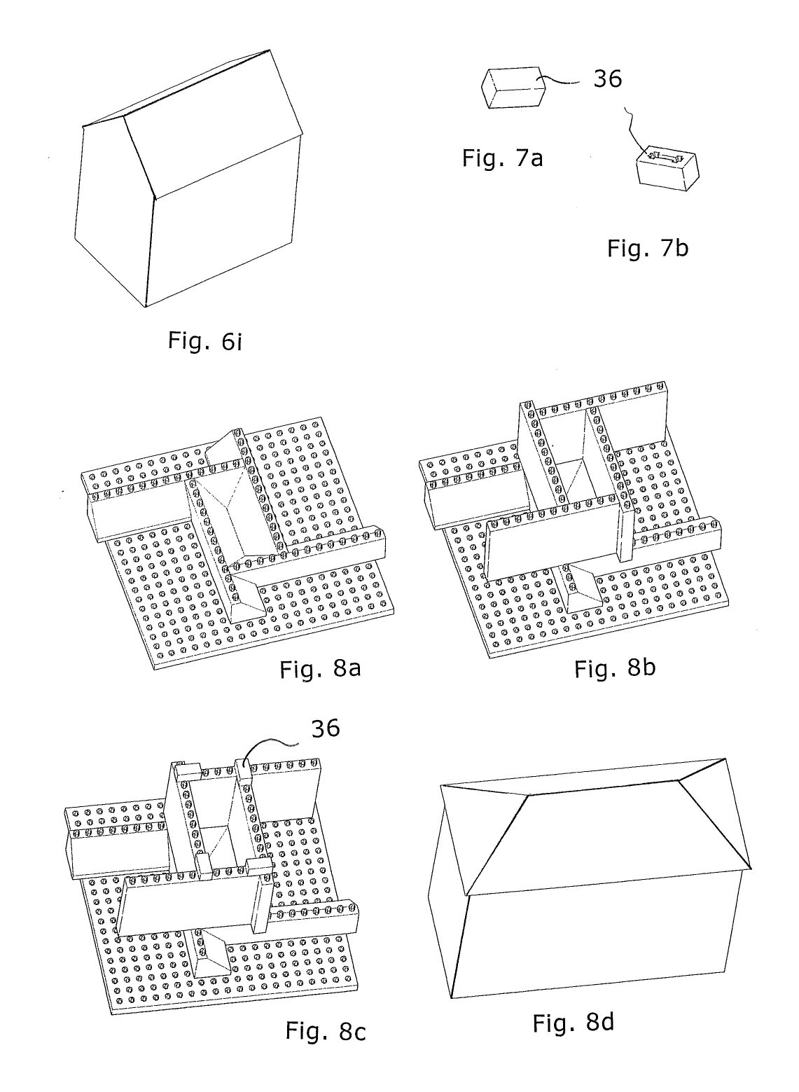

Further examples of how the casting mould is assembled are shown in FIG. 8 to 10 together with the finished product. As for the example, shown m FIG. 8, it should be noted that all four roof pieces are used with their inclined side as casting side, giving the finished product, in FIG. 8d, a different appearance than the product shown in FIG. 6i. Thus, even if the same pieces are used to assemble the casting mould, the result will be different. in FIG. 8c it should further be noted that the casting mould is locked with help of securing pieces 36. By enhancing the moulding kit with securing pieces 36, slits that may arise between the wall pieces may be eliminated. A detailed view of the securing piece is shown in FIGS. 7a and 7b.

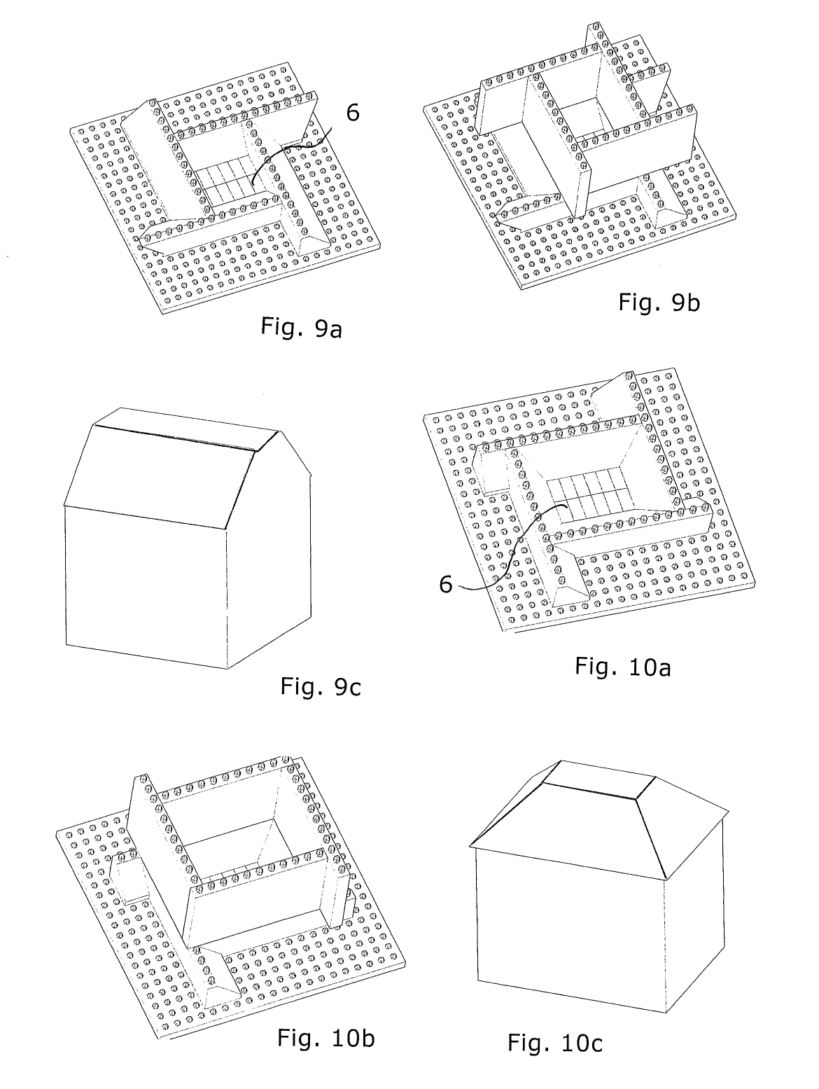

As for the examples shown in FIGS. 9 and 10, it will be desirable to use the roof eveners 6 described above in order to get an even top of the roof. Without the roof eveners 6, the dowels 4 of the base plate would make impressions on the final product. Thus, by adding roof eveners to the casting mould. kit, the kit will be even more useful and it will be possible to vary the end product even more. By using the casting mould kit according to the present invention it is possible to create a variety of construction models, with only a very few pieces. The casting mould is very easy to assemble and to disassemble and the shape of the dowels and recesses will secure that there will be no slippage between the pieces in the kit.

It shall be understood that even if the invention has been described with reference to preferred embodiments the invention is not limited thereto, There are many other embodiments and variations that are likewise within the scope of the invention, which is best defined by the accompanying claims.

1. A casting mould kit for moulding building models comprising a base plate provided with a grid of dowels on one side of the base plate, wall pieces having a rectangular shape and provided with dowels on a upper rim and with recesses on a lower rim and rod shaped roof pieces having a substantially triangular cross section provided with dowels on an upper rim and recesses at the lower base of the roof shaped piece and having an roof side with an inclination which is the opposite of the inclination of a short end side of the roof piece,

2. A casting mould kit according to claim 1, in which the dowels have a cross like cross section.

3. A casting mould kit according to claim 1, in which a casting side of the wall piece is hollow.

4. (canceled)

5. (canceled)

6. (canceled)

7. (canceled)

8. A casting mould kit according to claim 2, in which a casting side wall piece is hollow.

9. A casting mould kit according to claim 1, in which a casting side is provided with recesses for receiving adornments.

10. A casting mould kit according to claim 2, in which a casting side is provided with recesses for receiving adornments.

11. A casting mould kit according to claim 1, in which the kit further comprises securing pieces.

12. A casting mould kit according to claim 2, in which the kit further comprises securing pieces.

13. A casting mould kit according to claim 3, in which the kit further comprises securing pieces.

14. A casting mould kit according to claim 9, in which the kit further comprises securing pieces.

15. A casting mould kit according to claim 1, in which the kit further comprises roof eveners.

16. A casting mould kit according to claim 2, in which the kit further comprises roof eveners.

17. A casting mould kit according to claim 3, in which the kit further comprises roof eveners.

18. A casting mould kit according to claim 9, in which the kit further comprises roof eveners.

19. A casting mould kit according to claim 11, in which the kit further comprises roof eveners.

20. A casting mould kit according to claim 1, in which the roof side of the roof piece is hollow.

21. A casting mould kit according to claim 2, in which the roof side of the roof piece is hollow.

22. A casting mould kit according to claim 3, in which the roof side of the roof piece is hollow.

23. A casting mould kit according to claim 9, in which the roof side of the roof piece is hollow.

24. A casting mould kit according to claim 11, in which the roof side of the roof piece is hollow.
